(19) United States
(12) Patent Application Publication
(10) Pub. No.: US 2019/0114707 A1
(43) Pub. Date: Apr. 18, 2019

(54) Distribution of Blockchain Tokens

(71) Applicant: Shinestack LLC, Lebanon, ME (US)

(72) Inventors: Kevin McSheehan, Lebanon, ME (US); Corey Jackson, Lebanon, ME (US); Jevjenijs Steinbuks, Lebanon, ME (US); Robert Forster, Lebanon, ME (US); Greg Bailey, Lebanon, ME (US)

(73) Assignee: Shinestack LLC, Lebanon, ME (US)

(21) Appl. No.: 15/785,356

(22) Filed: Oct. 16, 2017

(51) Int. Cl. G06Q 40/04; G06Q 20/22; G06Q 20/06; G06Q 20/38

(52) U.S. Cl. CPC G06Q 40/04; G06Q 20/223; G06Q 2220/00; G06Q 20/3829; G06Q 20/3827; G06Q 20/0658

(57) ABSTRACT

Disclosed herein are system, method, and computer program product embodiments for introducing and removing blockchain based cryptocurrency tokens based on usage and demand for the cryptocurrency. An embodiment operates by transmitting, to a peer-to-peer network of computing devices configured to store a blockchain of processes, instructions for execution by one or more devices of the peer-to-peer network. The instructions comprise determining a rate of change associated with an exchange price of a cryptocurrency token. The instructions further include receiving an indication that a first amount of cryptocurrency tokens has been transferred to a recipient address of a plurality of addresses and generating a second amount of cryptocurrency tokens based on the first amount of cryptocurrency tokens that has been transferred and on the determined rate of change of the exchange price associated with the cryptocurrency token. The second amount of cryptocurrency tokens is allocated to the recipient address.

### BACKGROUND

### Technical Field

Embodiments generally relate to cryptocurrency techniques in computer networks.

### Background

A cryptocurrency can be described as a digital asset designed to work as a medium of exchange using cryptography to secure transactions and control the creation of additional units of the currency. Decentralized cryptocurrency systems such as Bitcoin and Ethereum have been developed and seen widespread adoption for a few years. Proponents of cryptocurrency tout its potential for providing its users with better security against fraud and theft, universal recognition across borders, and more direct access to markets, among other benefits. However, no cryptocurrency has been able to break into mainstream markets in a way comparable to traditional currency. Concerns remain regarding their feasibility due to the difficulty for governments to regulate them and control their supply. In particular, cryptocurrencies have suffered from substantial volatility in trading exchanges, leading to their increasing use for speculative trading instead of their originally intended use as a medium of asset exchange.

### SUMMARY

Disclosed herein are system, method, and computer program product embodiments for introducing and removing blockchain based cryptocurrency tokens based on usage and demand for the cryptocurrency. An embodiment operates by transmitting, to a peer-to-peer network of computing devices configured to store a blockchain of processes, instructions for execution by one or more devices of the peer-to-peer network. The instructions comprise determining a rate of change associated with an exchange price of a cryptocurrency token. The instructions further include receiving an indication that a first amount of cryptocurrency tokens has been transferred to a recipient address of a plurality of addresses and generating a second amount of cryptocurrency tokens based on the first amount of cryptocurrency tokens that has been transferred and on the determined rate of change of the exchange price associated with the cryptocurrency token. The second amount of cryptocurrency tokens is allocated to the recipient address. The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

The accompanying drawings are incorporated herein and form a part of the specification.

FIG. 1A illustrates a distributed networking environment usable for implementing blockchain methodologies, according to particular embodiments.

FIG. 1B illustrates a structure of a distributed blockchain network, according to particular embodiments.

FIG. 2 illustrates a cryptocurrency blockchain, according to particular embodiments.

FIG. 3 illustrates a method of performing a cryptocurrency transaction, according to particular embodiments.

FIG. 4 illustrates a cryptocurrency platform for generating, exchanging, and using a cryptocurrency using the techniques described above, according to particular embodiments.

FIG. 5 is a flowchart for a method for issuing platform tokens in a distributed cryptocurrency system, according to particular embodiments.

FIG. 6 is a flowchart for a method for managing platform token price drops in a distributed cryptocurrency system, according to particular embodiments.

FIG. 7 is a flowchart for a method for determining a price of a token in a distributed cryptocurrency system, according to particular embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for introducing and removing blockchain based cryptocurrency tokens based on usage and demand for the cryptocurrency.

Particular embodiments may aim to incentivize merchants to adopt a cryptocurrency as a payment method by rewarding the merchants with newly minted tokens. Particular embodiments may further aim to stabilize the value of the cryptocurrency from volatility and sudden price swings. Particular embodiments may introduce and remove tokens from circulation at variable rates in response to changes in the demand for the tokens.

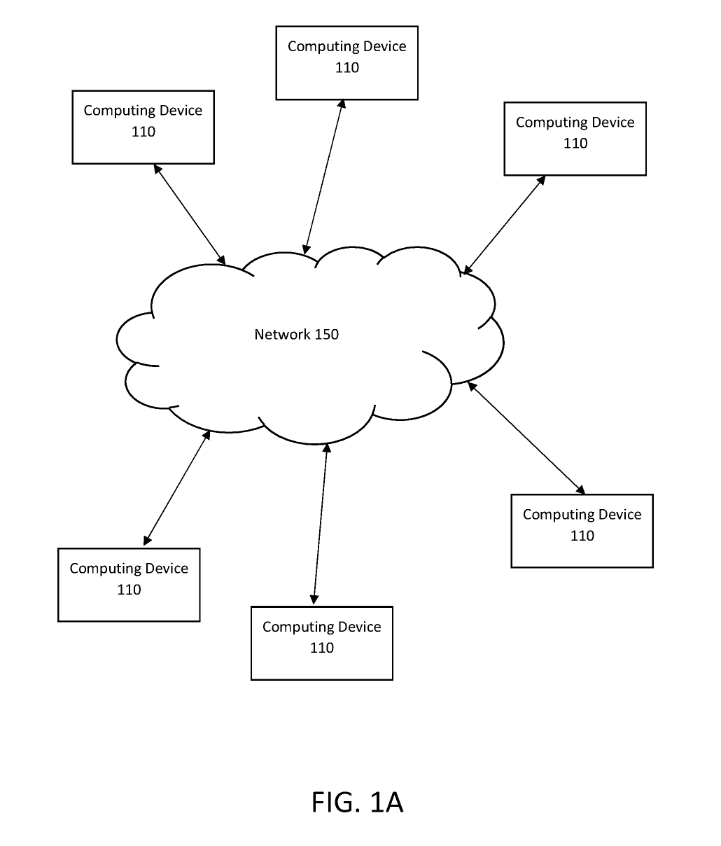

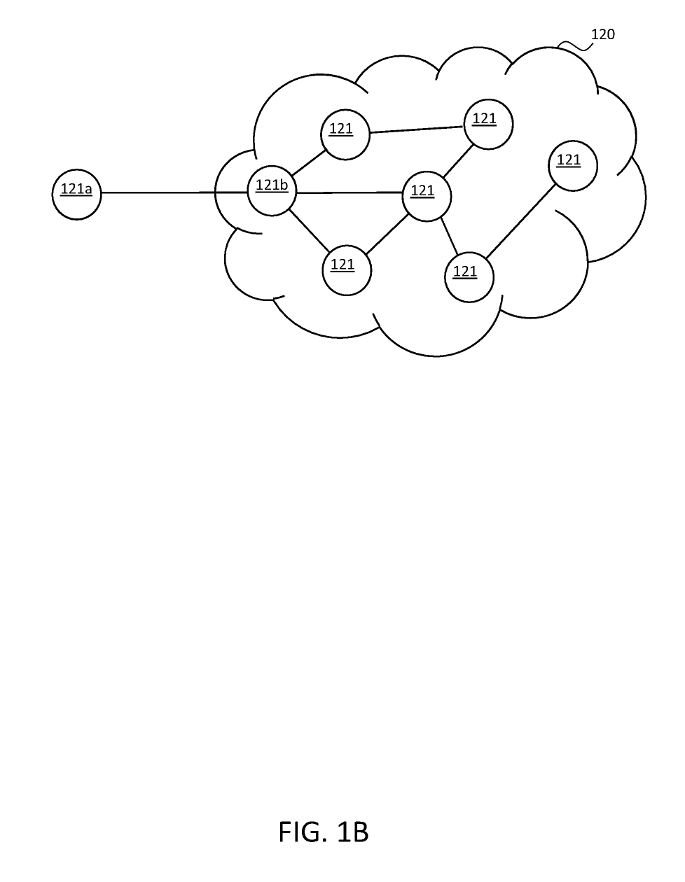

FIG. 1A illustrates a distributed networking environment 100 usable for implementing blockchain methodologies, according to particular embodiments. Distributed networking environment 100 includes multiple computing devices 110 communicating through a communications network 150. A computing device 110 may be any computing system including one or more processors, memory, and networking capability, such as, by way of example and not limitation, a personal computer, mobile computer, laptop computer, mobile phone, smartphone, personal digital assistant, tablet computer, server computers, database systems, storage area networks, web servers, application servers, or any combination thereof. Network 150 may be any communications network suitable for transmitting data between computing devices, such as, by way of example and not limitation, the Internet, a Local Area Network (LAN), a Wide Area Network (WAN), Metropolitan Area Network (MAN), Personal Area Network (PAN), wireless networks, satellite networks, overlay networks, or any combination thereof.

In particular embodiments, distributed cryptocurrency system 100 may be used to implement a distributed blockchain network 120. FIG. 1B illustrates a structure of a distributed blockchain network 120, according to particular embodiments. Each computing device 110 may implement one or more nodes 121 connecting to distributed blockchain network 121 using any suitable decentralized protocols, such as, peer-to-peer protocols, blockchain protocols, etc. A node 121 may be any combination of software and hardware configured to interact with distributed blockchain network 120, such as, by way of example, applications running on computers, web servers, mobile devices, virtual machines, etc.

Nodes 121 forming part of the distributed blockchain network may collectively execute instructions that implement various cryptocurrency functions, such as, for example, collectively storing, maintaining, and updating a blockchain ledger of account transactions and implementing smart contracts. A blockchain ledger (or blockchain, for short) comprises a data structure for storing information related to cryptocurrency accounts and transactions. As an example, nodes in the network may execute all or a portion of a transaction, and may cross-verify each other's transaction computations to prevent errors, manipulations, or fraudulent activity.

As an example, a node 121a may send a message a node 121b in distributed blockchain network 120, the message describing a transaction (e.g., a transfer of cryptocurrency from one account to another). Node 121b may further distribute the transaction details to a plurality of other nodes 121, who may further distribute the transaction or execute the transaction. Nodes 121 may further communicate and verify the results of the transaction. In particular embodiments, each node 121 may maintain a copy of a blockchain ledger, and may verify its accuracy based on other copies of the ledger in other nodes 121. While particular blockchain methodologies are described throughout, any suitable blockchain methodologies are contemplated by this disclosure.

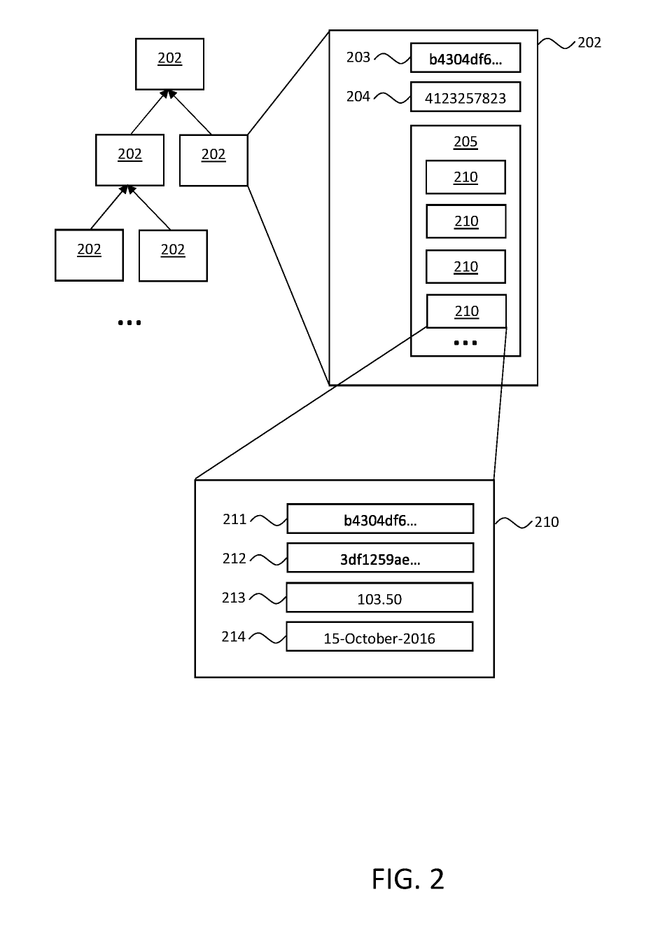

FIG. 2 illustrates a cryptocurrency blockchain 200, according to particular embodiments. In particular embodiments, one or more nodes 121 store a blockchain 200 representing a plurality of cryptocurrency token transactions. Blockchain 200 may comprise a distributed database of information used to keep records with protections against falsifications. Blockchain 200 may represent a list of blocks 202 that are linked and secured using cryptography. Each block 202 may record one or more transactions 210 of tokens from a sender user to a recipient user. As an example, each block 202 may include a hash pointer 203 to a prior block 202, a timestamp 204 indicating when the block was created, and a transaction ledger 205 containing one or more transaction records 210. Each transaction record 210 may contain a sender address 211, a recipient address 212, an amount 213 of cryptocurrency tokens transferred, and a time 214. In particular embodiments, blockchain 200 is maintained as a distributed database hosted among a plurality of computing devices communicating using a peer-to-peer networking protocol. These host devices may include some or all of computing devices 110. In particular embodiments, blockchain 200 is structured as a connected acyclic graph, such as, for example, a tree, binary tree, etc.

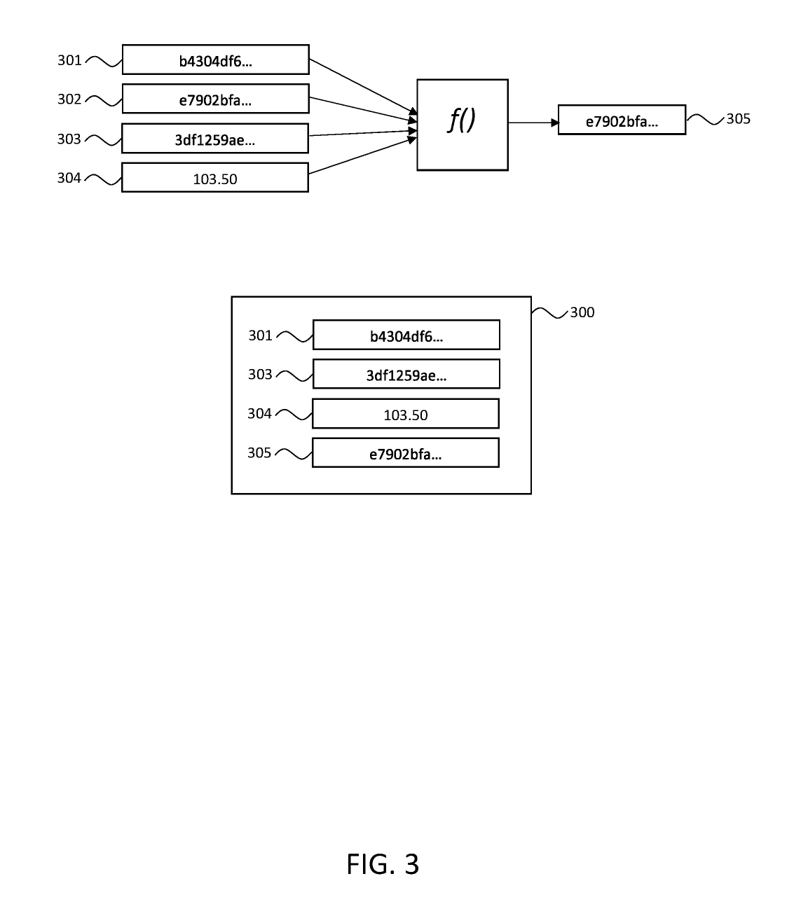

FIG. 3 illustrates a method of performing a cryptocurrency transaction, according to particular embodiments. For a user to perform a secure transaction, the user may utilize address 211 and a private key 311 as public and private cryptographic key pairs for verifying the authenticity of the transaction. Only a user with possession the correct private key 311 for an address 211 would be able to authorize a transaction associated with address 211 (i.e., public key). In this manner, each address 211 may be securely associated with an amount of cryptocurrency tokens, and may receive and transfer cryptocurrency tokens.

In particular embodiments, a node 121a may perform transactions that transfer an amount of cryptocurrency tokens between a sender and a recipient. To initiate a transaction, node 121a may create a transaction request 300. Node 121a may receive or access a public key 301 and private key 302 associated with the sender, public key 303 associated with the recipient, and the amount 304 of cryptocurrency tokens to transfer. Node 121a may receive or retrieve these values through any one or a combination of suitable means, such as, by way of example, reading from a memory, a storage device, a user input, a card input, a wallet client application, a QR-code input, a network transmission, etc. Node 121a may then input the sender's private key 302 and the transaction information (e.g., the sender's public key 301, the recipient's public key 303, and the transaction amount 304) into a cryptographic signature function (e.g., SHA, MDS, BLAKE, etc.) to generate a signature 305 for the transaction. Node 121a may then generate the transaction request 300 including the transaction details (301, 303, 304) along with the transaction signature 305.

Node 121a may then transmit the transaction request to one or more verifier nodes 121 in distributed blockchain network 120. In particular embodiments, a transaction request 300 may be verified using cryptographic function along with public key 301 and signature 305 to determine whether the signature produced is valid. In particular embodiments, some or all nodes 121 may perform transaction verification tasks, or other designated nodes 121 in distributed blockchain network 120 may perform verification tasks.

In particular embodiments, once transaction request 300 has been verified, one or more nodes may update the blockchain 200 by adding a transaction 210 corresponding to transaction request 300 to a new block 202. Updating blockchain 200 may be performed using any suitable cryptocurrency techniques, such as, by way of example, proof-of-work mining techniques, proof-of-stake mining techniques, etc.

In particular embodiments, distributed blockchain network 120 implements a virtual machine configured to execute code through use of nodes 121. In particular embodiments, blockchain 200 records instructions and states for blockchain executable processes, also known as smart contracts, self-executing contracts, blockchain contracts, digital contracts, etc. These blockchain processes may be collectively executed by nodes 121 in distributed blockchain network 120. Nodes 121 may store, maintain, execute, and update all or a portion of processes and their states, and cross-verify the accuracy of the results to avoid errors, manipulation, or fraud.

As an example of the operation of blockchain executable processes, a node 121a may be a server providing streaming video services. A video creator may create and upload videos to node 121a, and node 121a may stream the videos to consumer in exchange for money (e.g., subscription, pay-to-view basis, etc.). Node 121a may create blockchain functions that implement a contract with video provider to pay the provider based on views on their videos. For example, a blockchain function may be automatically called when a consumer plays a video, and the blockchain function may execute instructions that automatically transfer an amount of cryptocurrency to the video provider. As another example, node 121a may be a live video streaming service that creates one or more blockchain processes that automatically transfers cryptocurrency to video streamers based on viewership, time spent streaming, viewer donations, etc.

While a distributed blockchain network has been described using particular methodologies, this disclosure contemplates a distributed blockchain network using any suitable methodologies. In particular embodiments, distributed blockchain network 120 is based on a blockchain platform that supports smarts contracts, such as the Ethereum blockchain platform. In particular embodiments, tokens are ERC20 tokens that inherit ERC20 properties, functions, and events for smarts contracts implementation. As an example, the token may be transferrable between token holders and platforms using ERC20-compatible wallets, and may be integrated into cryptocurrency coin exchanges.

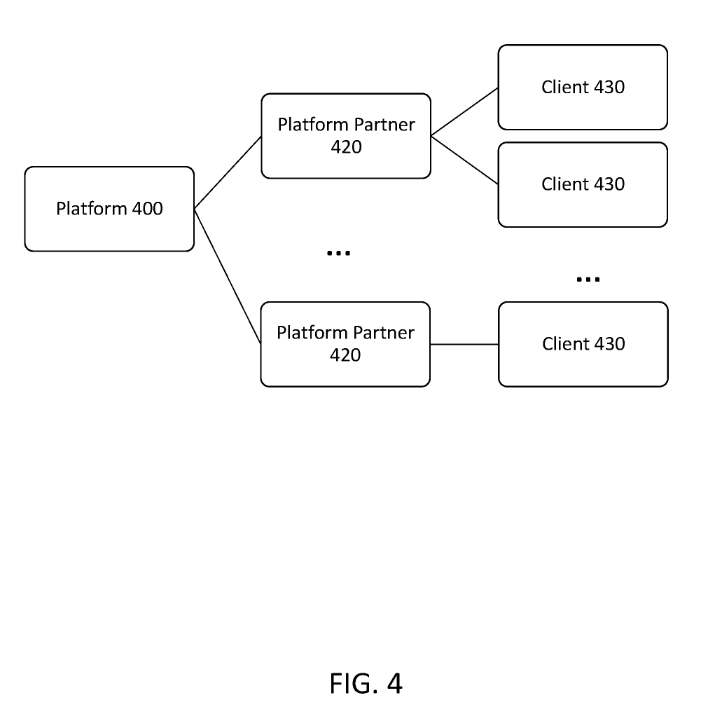

FIG. 4 illustrates a cryptocurrency platform 400 for generating, exchanging, and using a cryptocurrency using the techniques described above, according to particular embodiments. Platform 400 may include one or more platform managers 410, platform partners 420 and clients 430, each comprising one or more computing devices 110 and distributed blockchain network nodes 121 as described above. In particular embodiments, platform manager 410 may comprise a one or more computing devices associated with a single entity that conducts some functions described below in a centralized manner. In particular embodiments, platform manager 410 may comprise one or more nodes 121 and performs its functions in a decentralized manner.

Platform partners 420 may be any businesses, merchants, exchanges, services, platforms and other entities that adopt platform 400 to enable the trade, use, and exchange of cryptocurrency tokens for goods, services, or other currency. Clients 430 may be end-users of one or more platform partners. Clients 430 may be associated with one or more accounts or wallets, which in turn may be associated with one or more addresses for holding cryptocurrency tokens. As one example, a platform partner 420 may be associated with a video-streaming system that allows content providers to receive payment from content viewers for live-streaming video. In particular embodiments, platform partners 420 communicate with platform managers 410 to integrate a cryptocurrency token into the partner's system, referred to in the rest of this disclosure as the platform token. As an example, a platform partner 420 may adopt platform 400 and receive various platform tokens in exchange for traditional currency (e.g., US Dollar, Euros, etc.). Platform partners may then exchange some of the platform tokens for traditional currency from clients 430. Clients 430 may hold the platform tokens in their associated addresses, and may exchange the tokens to obtain goods and/or services. As an example, a video-streaming platform may allow its users to exchange money for platform tokens, and the users may use those platform tokens to pay for video-streaming services from content providers.

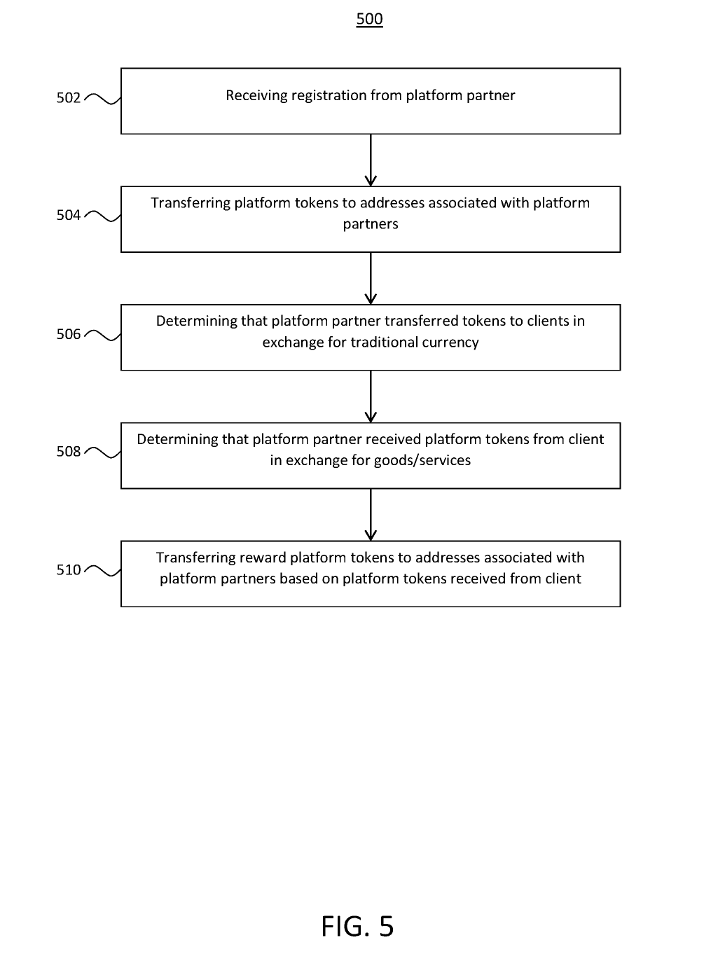

FIG. 5 is a flowchart for a method 500 for issuing platform tokens in a distributed cryptocurrency system, according to particular embodiments. Method 500 can be performed by processing logic that can comprise hardware (e.g., circuitry, dedicated logic, programmable logic, microcode, etc.), software (e.g., instructions run on a processing device), or a combination thereof. At step 502, a platform partner registers with a platform manager 410 to join platform 400. A platform partner 420 may join the platform through any suitable means. As an example, an administrator of platform partner 420 may register and configure its website service through a user interface. In particular embodiments, platform partner 420 may integrate its service through the use of application programming interfaces (APIs).

At step 504, platform manager 410 receives a number of platform tokens in exchange for traditional currency. Platform manager 410 may transfer platform tokens to addresses associated with platform partners 420. In particular embodiments, a platform partner may receive platform tokens upon joining platform 400. In particular embodiments, platform manager 410 maintains a bonus vault of platform tokens for the issuance of signing bonuses for new platform partners. As an example, a new platform partner 420 may receive 5% of the bonus vault's platform tokens on a first-come, first-served basis upon joining.

At step 506, platform partner may transfer a number of platform tokens to one or more clients 430 in exchange for traditional currency. As an example, a user (client 430) of a video-streaming service (420) may join the service an exchange US Dollars for an amount of platform tokens for use within the video-streaming service. A different user (different client 430) may receive platform tokens from the first user in exchange for providing goods and/or services, e.g., a video-stream of a video game session.

At step 508, a platform partner 420 may receive an amount of platform tokens from a client 430 in exchange for goods and/or services from platform partner 420. In particular embodiments, any client 430 may use platform tokens to transact with any platform partner 420. As an example, a client 430 of one platform 420 may use his/her platform tokens on any system associated with platform partner 420 that has joined platform 400. As an example, a user of video-streaming service may exchange platform tokens at a system associated with different platform partner 420 in exchange for goods and/or services (e.g., an online store, ride-sharing app, social-network, etc.).

At step 510, a platform manager 410 may provide amount of reward platform tokens to a platform partner 420 in response to the platform partner accepting a payment with platform tokens. In particular embodiments, the reward platform tokens are transferred to the platform partner 420 automatically as a result of a blockchain smart contract implemented between platform manager 410 and the platform partner 420. In particular embodiments, the smart contract is configured to mint a new amount of platform tokens at a reward rate after every platform token transaction. As an example, the reward rate may correspond to a percentage of the platform tokens received by platform partner 420 in a transaction with a client 430. As an example, a user (client 430) may pay a video-streaming service (partner platform 420) ten platform tokens for streaming services. Platform manager 410 may then mint a percentage (e.g., 0.05%) of the platform tokens paid (10) as new platform tokens (e.g., 0.005 new tokens) and transfer the newly minted platform tokens to the video-streaming platform as a reward for accepting the platform tokens.

Because using platform tokens in exchange for goods/services yields a concrete gain, users may prefer to use the platform tokens in this manner instead of trading the tokens for traditional currency in currency exchanges. Additionally, platform partners 420 may choose to provide rewards to its clients 430 to further incentivize use of their service and platform tokens. A resulting lower volume of speculative trading of the platform tokens may reduce volatility in its value, and further disincentivize its exchange. In this manner, platform 410 may incentivize use of platform 400 and platform tokens for goods and services, and potentially reduce volatility in the value of the platform tokens.

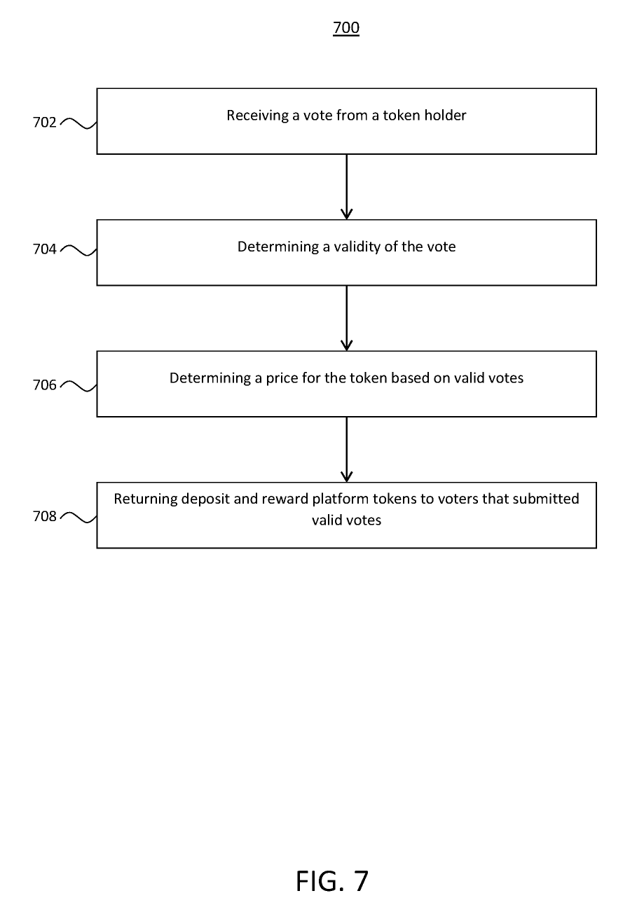

In particular embodiments, the reward rate may be variable. In particular embodiments, the reward rate is directly proportional to the price of the platform token, so that when the price of the platform token rises the reward rate also rises. As an example, when the rate of change over time of the price of the platform token is positive, the reward rate may be set to a positive value. In particular embodiments, when the rate of change of the price is negative, the reward rate is set to some minimum value, or zero. In particular embodiments, the reward rate depends on the derivative of an inflation index of goods and services denominated for purchase using platform tokens, as described in the equations below. The inflation index of platform token denominated goods and services indicates the cost of the goods and services, so an increase in the inflation index may indicate a depreciation in the price of the platform token. The price of the token may be determined using any suitable methods for valuating currency, such as price vs. demand metrics, currency exchange rates, currency trading prices, etc. In particular embodiments, the price of the platform token is determined using a method 700 described below with reference to FIG. 7.

In this manner, if the demand for platform token rises then the reward rate rises, thus introducing newly minted platform tokens into the platform economy and increasing the supply of platform tokens at a higher rate. This in turn may stabilize the price of platform token and reduce its volatility. In particular embodiments, the reward rate is hard-capped at a predetermined rate, (e.g., 10%).

Platform manager 410 may further initiate blockchain processes that serve as smart contracts to manage volatility, named volatility processes for purposes of this disclosure. In particular embodiments, platform manager 410 may use volatility processes to remove platform tokens from circulation for a period of time. Availability process may perform a transfer of platform tokens from one or more client addresses to another address designated for holding the tokens.

In particular embodiments, the volatility processes may be associated with a variable volatility bonus rate established at the time of creation of the process. Platform manager 410 may return the platform tokens associated with a volatility process and transfer an additional amount of bonus platform tokens based on the volatility bonus rate. In particular embodiments, the client 430 may be required to wait a specified time period before withdrawing the platform tokens in order to receive the bonus platform tokens.

In particular embodiments, platform manager 410 may increase the bonus rate of new volatility processes in response to a platform token price decrease. The volatility bonus rate may be inversely proportional to the price of platform tokens. In this manner, platform manager 410 may incentivize clients 430 to temporarily remove platform tokens from circulation during low demand/high supply/low price scenarios. As an example, an excessive amount of platform tokens in circulation and low demand for them may cause their price to drop. When this happens, platform manager 410 may offer volatility processes with higher bonus rates to clients 430, who may be incentivized to enter into them in order to obtain bonus tokens. The platform tokens held in volatility processes are thus temporarily removed from circulation, decreasing the supply of platform tokens for a period of time and increasing their price. Conversely, if the supply of platform tokens decreases, increasing the token's price, then platform manager 410 may offer volatility processes with lower bonus rates to clients 430. The offering of volatility processes may also depend on the token prices. In this manner, platform 410 may reduce the volatility of platform token prices, discourage their use in speculative trading, and incentivize their adoption for the exchange of goods and services.

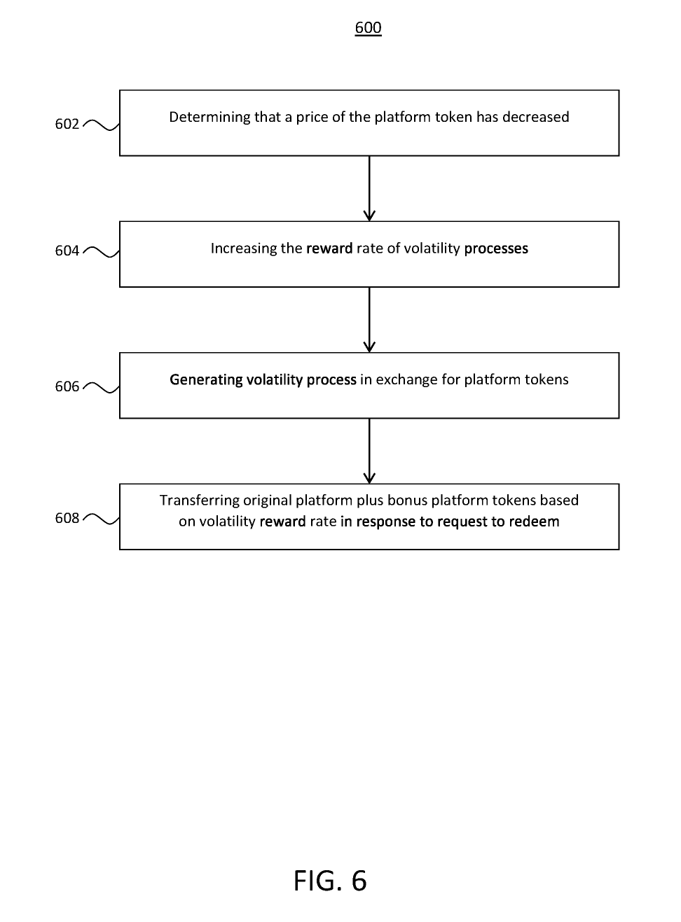

FIG. 6 is a flowchart for a method 600 for managing platform token price drops in a distributed cryptocurrency system, according to particular embodiments. Method 600 can be performed by processing logic that can comprise hardware (e.g., circuitry, dedicated logic, programmable logic, microcode, etc.), software (e.g., instructions run on a processing device), or a combination thereof. At step 602, platform manager 410 determines that the price of the platform token has decreased. At step 604, platform manager 410 may increase the volatility bonus rate of volatility processes. At step 606, platform manager 410 may initiate a volatility process that transfers a number platform tokens from a platform 420 or client 430. At step 608, platform manager 410 may receive a request to return the number of platform tokens to the platform 420 or client 430 for and transfers the original number of platform tokens plus a number of bonus platform tokens based on the volatility bonus rate. In particular embodiments, platform manager 410 may maintain platform tokens associated with volatility processes at an address associated with a volatility process reserve vault.

In particular embodiments, method 500 for distributing platform tokens and rewards and method 600 for managing platform token price decreases and volatility processes operate as described by the equations below. The equations below operate under the assumption that token price index P (i.e., an inflation index of goods and services denominated for purchase using platform tokens) is a known variable. Embodiments that determine the token price may use method 700, described below with reference to FIG. 7.

Platform token circulation equation:

MₜVₜ=PₜYₜ

Product demand equation:

$$\frac{{dY}_{t}}{{Y}_{t}} = β + γ [ \frac{{dM}_{t}}{{M}_{t}} - \frac{{dP}_{t}}{{P}_{t}} ]$$

Speculative transactions velocity:

$${V}_{t} = 1 + k [ \frac{{M}_{t} - {B}_{t} - {P}_{t} {Y}_{t}}{{M}_{t}} ]$$

Platform token reward rate targeting:

$$r = max \{ 0 , z [ \frac{{dM}_{t}}{{M}_{t}} - \frac{{dP}_{t}}{{P}_{t}} ] \}$$

Platform token supply:

$$\frac{{dM}_{t}}{{M}_{t}} = \frac{{Y}_{t} [ r ( 1 - μ ) ] + {W}_{t}}{{M}_{t}}$$

Returns paid for volatility process j being redeemed at time t:

Wₜ=ΣᵢBⱼRⱼ

Volatility process rate targeting:

$$R = max \{ 0 , - δ [ \frac{{dM}_{t}}{{M}_{t}} - \frac{{dP}_{t}}{{P}_{t}} ] \}$$

Variables:
M, platform token supply
V, speculative transactions
Y, product output/demand
P, platform price index
r, reward rate
R, volatility process return rate
Bⱼ, platform token value for volatility process j
Bₜ, sum of all Bⱼ outstanding at time t
Rᵢ return rate for volatility process Bⱼ established when bought

Model parameters:
β, output growth rate per period t
γ, elasticity of output growth to an increase in real platform token supply
k, elasticity of speculative transactions to platform token excess supply
z, sensitivity of reward rate to real money supply
δ, sensitivity of volatility process return rate to real platform token supply
μ, platform token deposit insurance

Particular embodiments and methods described above may depend on determining the price of the token in the distributed cryptocurrency system. Determining a price of a token may not be trivial in certain situations. For example, there may not be a trusted entity that determines a price, or high volatility may make it hard to determine a price.

FIG. 7 is a flowchart for a method 700 for determining a price of a token in a distributed cryptocurrency system, according to particular embodiments. Method 700 can be performed by processing logic that can comprise hardware (e.g., circuitry, dedicated logic, programmable logic, microcode, etc.), software (e.g., instructions run on a processing device), or a combination thereof.

Method 700 may involve voting by token holders on a price of the token using a votechain, or a blockchain that keeps track of voting as described below. In particular embodiments, a token price is represented as an exchange rate between tokens and a traditional currency (e.g., token/USD, token/Euro, etc.).

At step 702, platform manager 410 receives a vote from a token holder. The vote may include a deposit in tokens, a hash based on the current price of the token, a prior price of the token corresponding to a previously submitted vote by the token holder (for which the hash was submitted in the previous vote), and an address associated with token holder.

At step 704, platform manager 410 determines a validity of the vote. If a submitted vote does not match a previously submitted hash, the vote is considered invalid. Furthermore, if the submitted prior price is not within a percentile range of submitted prices, given a sample size exceeding a predetermined sample size, the vote is considered invalid. Otherwise, the vote is considered valid. As an example, if a prior price is a statistical outlier, the vote is not counted. An outlier may be determined using any suitable statistical techniques, e.g., three times the standard deviation, etc.

At step 706, platform manager 410 determines a price for the token based on the valid votes. In particular embodiments, the price is determined based on a weighed vote correlated to the size of the deposit associated with each vote.

At 708, platform manager 410 returns the corresponding deposit tokens to the addresses of valid votes, and further awards an additional number of tokens correlated the deposit. If the vote was considered invalid, the deposit is not returned.

In particular embodiments, method 700 may be vulnerable to voter manipulation through a coordinate collusion by a plurality of voters. As an example, many voters may collude to vote on a particular incorrect price for their personal benefit. In such a scenario, a fail-safe voting mechanism may be employed, such as, by way of example, an open-source exchange polling and voting automation with real-time log output. In particular embodiments, platform manager 410 may issue microtransactions to a cryptocurrency exchange platform to determine a price of the platform tokens. As an example, platform manager 410 may issue a transaction to exchange an amount of platform token for a cryptocurrency token anchored to a fiat currency (e.g., Tether).

In particular embodiments, volatility processes may be exchanged as assets between addresses associated with platform tokens. As an example, a party to a volatility process may sell the rights to redeem the tokens (and reward tokens) associated with a volatility process, and a buyer may redeem the tokens associated with the volatility process at a later time. In particular embodiments, the prices of volatility processes are determined using method 700, as explained above with reference to platform tokens. In particular embodiments, platform 410 may employ further security mechanisms to avoid manipulation of volatility process prices. In particular embodiments, platform 410 may randomize the time at which a new process comes into effect after voting through method 700 takes place for processes. In this manner, platform 410 may avoid a level of predictability that would allow vote manipulators to know the optimal times to buy processes. In particular embodiments, platform 410 may enact a fee when distributing volatility processes or require a holding time. In this manner, platform 410 may discourage market activity that resembles speculative trading. In particular embodiments, platform 410 enables the ability to buy enter into volatility processes only after the platform token price has decreased for a predetermined period of time. In particular embodiments, platform 410 may apply one or more signal processing techniques to limit the magnitude or timing of reaction to changes in platform token price, such as slew rate limiting to limit price change per unit time, or low-pass filtering to introduce lag and limit reaction to rapid changes, such as transients or oscillations, in raw price data.

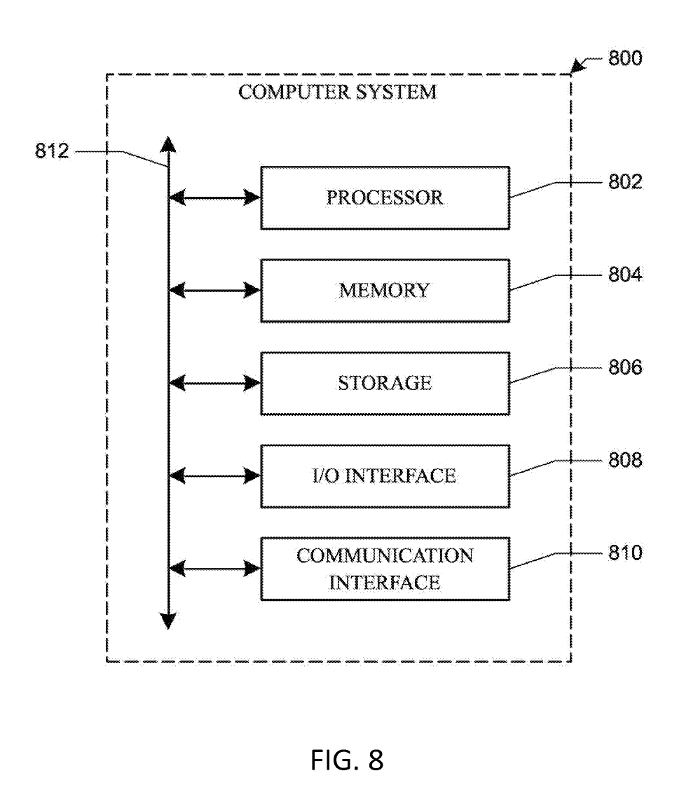

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example, computer system 800 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, memory 804 includes random access memory (RAM). This RAM may be volatile memory, where appropriate Memory 804 may include one or more memories 804, where appropriate. Although this disclosure describes and illustrates particular memory, this disclosure contemplates any suitable memory.

In particular embodiments, storage 806 includes mass storage for data or instructions. As an example, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

What is claimed is:

1. A computer-implemented method comprising, by at least one processor:
transmitting, to a peer-to-peer network of computing devices configured to store a blockchain of processes, instructions for execution by one or more devices of the peer-to-peer network, the instructions comprising:
determining a rate of change associated with an exchange price of a cryptocurrency token;
receiving an indication that a first amount of cryptocurrency tokens has been transferred to a recipient address of a plurality of addresses; and
generating a second amount of cryptocurrency tokens based on the first amount of cryptocurrency tokens that has been transferred and on the determined rate of change of the exchange price associated with the cryptocurrency token, wherein the second amount of cryptocurrency tokens is allocated to the recipient address.

2. The method of claim 1, wherein the rate of change associated with the exchange price of the cryptocurrency token comprises an inflation rate associated with the exchange price of the cryptocurrency tokens.

3. The method of claim 1, the instructions further comprising:
determining that a price of the cryptocurrency tokens has decreased by a specified amount; and
in response to the determined decrease of the price of the cryptocurrency, receiving a third amount of the cryptocurrency tokens from the recipient address at a holding address.

4. The method of claim 3, the instructions further comprising:
transferring the third amount of the cryptocurrency tokens from the holding address to the recipient address and an additional amount of the cryptocurrency tokens.

5. The method of claim 4, wherein the additional amount of cryptocurrency tokens is based on the determined rate of change associated with the exchange price of the cryptocurrency token and a length of time that the holding address held the third amount of the cryptocurrency tokens.

6. The method of claim 1, further comprising, by the at least one processor:
receiving a first message comprising a first deposit of cryptocurrency tokens, a first hash of a current price of the cryptocurrency tokens, a first prior price of the cryptocurrency tokens, and an address associated with the first message;
receiving a second message comprising a second deposit of cryptocurrency tokens, a second hash of a current price of the cryptocurrency tokens, a second prior price of the cryptocurrency tokens, and the address associated with the first message;
determining whether the second hash corresponds to the first prior price; and
in response to the determining the second hash corresponds to the first prior price, assigning a voting weight to the address associated with the first message, wherein the weight is correlated to the first deposit.

7. The method of claim 6, further comprising, by the at least one processor:
transmitting, to the associated with the first message, a third amount of cryptocurrency tokens corresponding to the first deposit and an additional amount of cryptocurrency tokens.

8. A system, comprising:
a memory; and
at least one processor coupled to the memory and configured to:
transmit, to a peer-to-peer network of computing devices configured to store a blockchain of processes, instructions for execution by one or more devices of the peer-to-peer network, the instructions comprising:
determining a rate of change associated with an exchange price of a cryptocurrency token;
receiving an indication that a first amount of cryptocurrency tokens has been transferred to a recipient address of a plurality of addresses; and
generating a second amount of cryptocurrency tokens based on the first amount of cryptocurrency tokens that has been transferred and on the determined rate of change of the exchange price associated with the cryptocurrency token, wherein the second amount of cryptocurrency tokens is allocated to the recipient address.

9. The system of claim 8, wherein the rate of change associated with the exchange price of the cryptocurrency token comprises an inflation rate associated with the exchange price of the cryptocurrency tokens.

10. The system of claim 8, the instructions further comprising:
determining that a price of the cryptocurrency tokens has decreased by a specified amount; and
in response to the determined decrease of the price of the cryptocurrency, receiving a third amount of the cryptocurrency tokens from the recipient address at a holding address.

11. The system of claim 10, the instructions further comprising:
transferring the third amount of the cryptocurrency tokens from the holding address to the recipient address and an additional amount of the cryptocurrency tokens.

12. The system of claim 11, wherein the additional amount of cryptocurrency tokens is based on the determined rate of change associated with the exchange price of the cryptocurrency token and a length of time that the holding address held the third amount of the cryptocurrency tokens.

13. The system of claim 8, the processor further configured to:
receive a first message comprising a first deposit of cryptocurrency tokens, a first hash of a current price of the cryptocurrency tokens, a first prior price of the cryptocurrency tokens, and an address associated with the first message;
receive a second message comprising a second deposit of cryptocurrency tokens, a second hash of a current price of the cryptocurrency tokens, a second prior price of the cryptocurrency tokens, and the address associated with the first message;
determine whether the second hash corresponds to the first prior price; and
in response to the determining the second hash corresponds to the first prior price, assign a voting weight to the address associated with the first message, wherein the weight is correlated to the first deposit.

14. The system of claim 13, the processor further configured to:
transmit, to the associated with the first message, a third amount of cryptocurrency tokens corresponding to the first deposit and an additional amount of cryptocurrency tokens.

15. A tangible computer-readable device having instructions stored thereon that, when executed by at least one computing device, causes the at least one computing device to perform operations comprising:
transmitting, to a peer-to-peer network of computing devices configured to store a blockchain of processes, instructions for execution by one or more devices of the peer-to-peer network, the instructions comprising:
determining a rate of change associated with an exchange price of a cryptocurrency token;
receiving an indication that a first amount of cryptocurrency tokens has been transferred to a recipient address of a plurality of addresses; and
generating a second amount of cryptocurrency tokens based on the first amount of cryptocurrency tokens that has been transferred and on the determined rate of change of the exchange price associated with the cryptocurrency token, wherein the second amount of cryptocurrency tokens is allocated to the recipient address.

16. The computer-readable device of claim 15, wherein the rate of change associated with the exchange price of the cryptocurrency token comprises an inflation rate associated with the exchange price of the cryptocurrency tokens.

17. The computer-readable device of claim 15, the instructions further comprising:
determining that a price of the cryptocurrency tokens has decreased by a specified amount; and
in response to the determined decrease of the price of the cryptocurrency, receiving a third amount of the cryptocurrency tokens from the recipient address at a holding address.

18. The computer-readable device of claim 17, the instructions further comprising:
transferring the third amount of the cryptocurrency tokens from the holding address to the recipient address and an additional amount of the cryptocurrency tokens.

19. The computer-readable device of claim 18, wherein the additional amount of cryptocurrency tokens is based on the determined rate of change associated with the exchange price of the cryptocurrency token and a length of time that the holding address held the third amount of the cryptocurrency tokens.

20. The computer-readable device of claim 15, the operations further comprising:
receiving a first message comprising a first deposit of cryptocurrency tokens, a first hash of a current price of the cryptocurrency tokens, a first prior price of the cryptocurrency tokens, and an address associated with the first message;
receiving a second message comprising a second deposit of cryptocurrency tokens, a second hash of a current price of the cryptocurrency tokens, a second prior price of the cryptocurrency tokens, and the address associated with the first message;
determining whether the second hash corresponds to the first prior price; and
in response to the determining the second hash corresponds to the first prior price, assigning a voting weight to the address associated with the first message, wherein the weight is correlated to the first deposit.
